(19) United States
(12) Patent Application Publication
(10) Pub. No.: US 2020/0306854 A1
(43) Pub. Date: Oct. 1, 2020

(54) METHOD FOR JOINING DIFFERENT TYPE OF METALS AND LASER WELDING DEVICE

(71) Applicant: UACJ CORPORATION, Tokyo (JP)

(72) Inventors: Shohei YOMOGIDA, Tokyo (JP); Takeshi MURASE, Tokyo (JP); Toshihiko FUKUDA, Tokyo (JP)

(73) Assignee: UACJ CORPORATION, Tokyo (JP)

(21) Appl. No.: 16/635,151

(22) PCT Filed: Jul. 18, 2018
(86) PCT No.: PCT/JP2018/026821

§ 371 Date: Jan. 29, 2020

(30) Foreign Application Priority Data
Jul. 31, 2017 (JP) 2017-147770

(51) Int. Cl. B23K 1/005; B23K 1/19; B23K 3/06

(52) U.S. Cl. CPC B23K 1/0056; B23K 2103/10; B23K 3/0607; B23K 1/19

(57) ABSTRACT

In a method for joining different type of metals, an Al-based base material (2) made of an Al alloy or pure Al and a Cu-based base material (3) made of a Cu alloy or pure Cu are joined to each other. The Al-based base material (2) and the Cu-based base material (3) are joined to each other by laser welding for melting and solidifying a portion irradiated with laser light using a filler metal (5) made of an Al alloy containing at least one of Si and Cu.

### CROSS REFERENCE TO RELATED APPLICATIONS

The present application is an International Patent Application No. PCT/JP2018/026821 filed on Jul. 18, 2018, which claims priority to Japanese Patent Application No. 2017-147770 filed on Jul. 31, 2017. The contents of these applications are incorporated herein by reference in their entirety.

### BACKGROUND

### Technical Field

The present invention relates to a method for joining different type of metals, the different type of metals being an Al-based base material made of an Al alloy or pure Al and a Cu-based base material made of a Cu alloy or pure Cu, and a laser welding device.

### Background

Generally, Cu (copper)-based materials made of Cu alloys or pure Cu have high electrical conductivity and are therefore used for, for example, electrodes and bus bars for Li (lithium) ion batteries, and electrodes, terminals, and wiring for electronic devices and wire harnesses and the like. In recent years, from the viewpoint of environmental protection, research and development of hybrid cars and electric cars and the like have been rapidly advanced, and weight reduction is required of Li ion batteries, electronic devices, and electrical parts and the like mounted in these cars and the like. In order to achieve the weight reduction of these power sources and electrical parts and the like, forming some of the electrodes and the terminals and the like with A (aluminum)-based materials made of Al alloys or pure Al instead of Cu-based materials is studied.

More specifically, in the above electrical parts and the like, electrodes and terminals and the like made of Cu-based materials, and electrodes and terminals and the like made of Al-based materials are mixed, and techniques for joining the different type of metals to each other are therefore required. Examples of the methods for joining different type of metals to each other include ultrasonic joining, MIG welding, friction stir welding (FSW), and laser welding. Among these joining methods, in particular, the laser welding provides a higher power density, and therefore the laser welding is most excellent from the viewpoint of productivity.

In the laser welding, a laser welder condenses laser light on two base materials to be welded, and irradiates the base materials with the condensed laser light. The irradiated laser light is condensed in the form of, for example, a circular spot so that a focal point of the laser light is located around the surfaces of the base materials by a lens or a mirror and the like. This makes it possible to condense the power (energy) of the laser light in a portion irradiated with the laser light, to provide a power density a hundred times to a thousand times of that of arc welding and the like.

The laser welding allows high speed welding, and provides a heat-affected zone having a narrow width, whereby the laser welding is suitable for joining different type of metals. As a method for joining base materials made of different type of metals to each other according to the laser welding, the optimization of the irradiation condition of laser has been actively studied from the viewpoints of control of a penetration shape and improvement in joint strength, and the like.

For example, Japanese Laid-Open Patent Publication No. 2005-254282 discloses a method for manufacturing a welded metal plate obtained by butt-laser welding metal plates having different melting points. The method of Japanese Laid-Open Patent Publication No. 2005-254282 moves a laser head so that the focal point of a laser beam is shifted to at least the upper surface side of a metal plate having a higher melting point with respect to an abutting position, to perform laser welding. It is an object of the method to obtain a non-perforated welding bead (weld metal portion) during the laser welding. However, in the invention disclosed in Japanese Laid-Open Patent Publication No. 2005-254282, the inhibition of cracks being apt to occur in the weld metal portion and the production amount of an intermetallic compound has not been studied. In addition, in Japanese Laid-Open Patent Publication No. 2005-254282, examples of the combinations of plates having different melting points when the plates are welded include only the cases of steel and aluminum-based plates, steel and copper-based plates, and steel and stainless steel plates. Examples of the combinations include no combination of an aluminum-based base material and a copper-based base material. For this reason, when an aluminum-based base material and a copper-based base material are laser-welded to each other using the method disclosed in Japanese Laid-Open Patent Publication No. 2005-254282, the laser head is moved so that the focal point of the laser beam is shifted to at least the upper surface side of the copper-based base material as the metal plate having a higher melting point with respect to the abutting position, to perform the laser welding. However, the copper-based base material has high thermal conductivity and light reflectivity, whereby the copper-based base material is less likely to be melted by the irradiation of the laser light. This makes it necessary to increase the energy density of the laser light to be irradiated in order to melt the copper-based base material. Furthermore, many intermetallic compounds having high brittleness, such as Cu₉Al₄ occur in a melted portion. This also causes a problemin that sufficient jointstrength cannot be obtained.

Japanese Laid-Open Patent Publication No. 2011-005499 discloses a method for laser-welding an aluminum member and a copper member to each other. In the laser welding method, the aluminum r ember and the copper member are irradiated with laser light so that an irradiation area of the laser light to the aluminum member is larger than that to the copper member. However, the laser welding method of Japanese Laid-Open Patent Publication No. 2011-005499 makes it necessary to strictly control an irradiation position in a butt joint, whereby the laser welding method causes a low degree of freedom for a joint shape and low tolerance in construction.

### SUMMARY OF INVENTION

The present embodiment is completed in consideration of the above circumstance and is related to providing a method for joining different type of metals, and a laser welding device. The method and the laser welding device join an Al-based base material and a Cu-based base material to each other according to laser welding using an optimized filler metal to eliminate the need for strict control of a laser radiation position and also can manufacture a welded joint having high joint strength.

The present inventors have investigated diligently, and have found that laser welding using an Al-based base material, a Cu-based base material, and an Al alloy containing at least one of Si and Cu and having a low melting point as a filler metal makes it possible to manufacture a welded joint of the Al-based and Cu-based base materials having high joint strength.

More specifically, the present embodiment primarily includes the following constituent features.
(1) A method for joining different type of metals, the different type of metals being an Al-based base material made of an Al alloy or pure Al and a Cu-based base material made of a Cu alloy or pure Cu,
wherein the Al-based base material and the Cu-based base material are joined to each other by laser welding for melting and solidifying a portion irradiated with laser light using a filler metal made of an Al alloy containing at least one of Si and Cu.
(2) The method for joining different type of metals according to (1), wherein the filler metal is an Al—Si-based alloy, an Al—Cu—Si-based alloy, or an Al—Cu—Si—Zn-based alloy.
(3) The method for joining different type of metals according to (1) or (2), wherein the filler metal is a powdered filler metal.
(4) The method for joining different type of metals according to (3), wherein:
a powder of the powdered filler metal is arranged in contact with the Cu-based base material on the Al-based base material; and
an irradiation spot of the laser light is scanned over a surface of the powder.
(5) The method for joining different type of metals according to (4), wherein the powder over which the irradiation spot of the laser light is scanned further contains an Fe powder occupying an area ratio of 1% or more on the surface of the powder.
(6) The method for joining different type of metals according to any one of (3) to (5), wherein a powder of the powdered filler metal further contains a flux at a volume ratio of 10% or more.
(7) The method for joining different type of metals according to any one of (1) to (6), wherein a welding condition in the laser welding includes a powerdensity of 50 kW/mm² or less and a welding speed of 1 mm more.
(8) A laser welding device used for joining different type of metals, the different type of metals being an Al-based base material made of an Al alloy or pure Al, and a Cu-based base material made of a Cu alloy or pure Cu,
wherein:
the laser welding device includes a laser emission unit and a filler metal supply unit;
the filler metal supply unit includes a filler metal supply portion storing a powdered filler metal made of an Al alloy containing at least one of Si and Cu, and supplying the stored powdered filler metal, and an Fe powder supply portion storing an Fe powder and supplying the stored Fe powder;
the filler metal supply portion supplies the powdered filler metal to a predetermined joining position, to allow a powder of the powdered filler metal to be arranged;
the Fe powder supply portion can supply and arrange the Fe powder on a surface of the powder arranged at the predetermined joining position; and
the laser emission unit can scan an irradiation spot of laser light over the surface of the powder on which the Fe powder is arranged.

The present embodiment can provide a method for joining different type of metals, and a laser welding device. The method and the laser welding device perform laser welding using an Al-based base material, a Cu-based base material, and an Al alloy containing at least one of Si and Cu and having a low melting point as a filler metal, to eliminate the need for strict control of a laser radiation position, and also can manufacture a welded joint of the Al-based and Cu-based base materials having high joint strength.

### BRIEF DESCRIPTION OF THE DRAWINGS

FIG. 1 is a specific perspective view shown to illustrate a method for joining different type of metals according to the present embodiment, and showing a state before joining in which an end portion of an upper plate (preferably a copper-based base material) is only overlaid on an end portion of a lower plate (preferably an aluminum-based base material).

FIG. 2 is a specific perspective view showing a state before joining when a powder of a powder filler metal is arranged in contact with an end face of the upper plate (preferably the copper-based base material) on the lower plate (preferably the aluminum-based base material) in a state in which the end portion of the upper plate is overlaid on the end portion of the lower plate as shown in FIG. 1.

FIG. 3 is a specific perspective view of a welded joint obtained by irradiating the surface of the powder arranged as shown in FIG. 2 with laser light for laser welding, to join the lower plate (preferably the aluminum-based base material) and the upper plate (preferably the copper-based base material) to each other.

FIG. 4 is a schematic cross-sectional view when the welded joint shown in FIG. 3 is cut perpendicularly to a welding direction X.

FIG. 5 is a diagram illustrating an arrangement relationship among an upper plate, a lower plate, and a laser emission unit and a filler metal supply unit constituting a laser welding device according to the present embodiment when a welded joint is manufactured according to a method for joining different type of metals of the present embodiment using the laser welding device according to the present embodiment.

### DETAILED DESCRIPTION

Hereinafter, a method for joining different type of metals according to the present embodiment will be described in detail.

### <Method for Joining Different Type of Metals>

A method for joining different type of metals according to the present embodiment is a method for joining different type of metals, the different type of metals being an Al-based base material made of an Al alloy or pure Al and a Cu-based base material made of a Cu alloy or pure Cu. The Al-based base material and the Cu-based base material are joined to each other by laser welding for melting and solidifying a portion irradiated with laser light using a filler metal made of an Al alloy containing at least one of Si and Cu.

### (Al-Based Base Material)

The Al (aluminum)-based base material is made of an Al alloy or pure Al. The aluminum alloy is not particularly limited, and examples of the aluminum alloy include an Al—Mn-based alloy (JIS 3000-based alloy), an Al—Mg-based alloy (JIS 5000-based alloy), and an Al—Mg—Si alloy (JIS 6000-based alloy). Examples of the pure aluminum include a JIS 1000-based alloy. Specific examples are A1100, A1050, A3003, A3004, A5052, A5083, and A6061 and the like.

### (Cu-Based Base Material)

The Cu (copper)-based base material is made of a Cu alloy or pure Cu. The copper alloy is not particularly limited, and examples of the copper alloy include a Cu—Zn-based alloy (brass) and a Cu—Sn-based alloy (bronze). Examples of the pure copper include oxygen-free copper, tough pitch copper, and phosphorus-deoxidized copper. Specific examples are C1020, C1100, C1201, C2600, C5191, and C6191 and the like.

### (Filler Metal)

### [Alloy Composition of Filler Metal]

The method for joining different type of metals according to the present embodiment uses a filler metal made of an Al alloy containing at least one of Si and Cu. Preferred examples of alloy composition systems of the filler metal include an Al—Si-based alloy, an Al—Cu-based alloy, an Al—Cu—Si-based alloy, an Al—Cu—Zn-based alloy, or an Al—Cu—Si—Zn-based alloy. Among these alloy composition systems, the Al—Si-based alloy, the Al—Cu—Si-based alloy, or the Al—Cu—Si—Zn-based alloy is preferably used as the filler metal. The filler metal made of an Al alloy has a melting point lower than the melting point (660° C.) of pure Al. It has been found that, when the Al-based base material and the copper-based base material are welded to each other, the production amount of an intermetallic compound is increased in a welded portion (a portion containing a weld metal portion and a heat-affected zone), resulting in decrease of joint strength and the production amount of the intermetallic compound is increased for a longer high-temperature time during welding. More specifically, since, in the present embodiment, laser welding using the filler metal having a low melting point as described above makes it possible to shorten the time during which the welded portion is under high temperature, the production amount of the intermetallic compound is inhibited. This makes it possible to manufacture a welded joint having high joint strength. The melting point of the filler metal is desirably lower than that of pure Al by 10° C. or higher.

When the filler metal is the Al—Si-based alloy, the content of Si is desirably 1 to 14% by mass. There is a tendency that, when the content of Si is less than 1% by mass, the melting point of the Al—Si-based alloy cannot be sufficiently reduced compared to the melting point of pure Al, the time during which the welded portion is under high temperature cannot be shortened, and the production of the intermetallic compound cannot be sufficiently inhibited. Meanwhile, there is a tendency that, when the content of Si exceeds 14% by mass, the melting point of the filler metal increases to cause an increase in the amount of the intermetallic compound formed in the welded portion.

It is preferable that, when the filler metal is the Al—Cu-based alloy, the content of Cu is 30% by mass or less. This is because, when the content of Cu is more than 30% by mass, the melting point of the filler metal increases, which cannot be likely to sufficiently exhibit an effect of inhibiting the amount of the intermetallic compound formed in the welded portion.

It is preferable that, when the filler metal is the Al—Cu—Si-based alloy, the content of Cu is 30% by mass or less, and the content of Si is 7% by mass or less. This is because, when at least one of the contents of Cu and Si is more than the above range, the melting point of the filler metal increases, which cannot be likely to sufficiently exhibit an effect of inhibiting the amount of the intermetallic compound formed in the welded portion.

It is preferable that, when the filler metal is the Al—Cu—Zn-based alloy, the content of Cu is 30% by mass or less, and the content of Zn is 7% by mass or less. This is because, when the contents of Cu and Zn are more than the above range, the melting point of the filler metal increases, which cannot be likely to sufficiently exhibit an effect of inhibiting the amount of the intermetallic compound formed in the welded portion.

It is preferable that, when the filler metal is the Al—Cu—Si—Zn-based alloy, the content of Cu is 30% by mass or less, the content of Si is 7% by mass or less, and the content of Zn is 7% by mass or less. This is because, when at least one of the contents of Cu, Si, and Zn is more than the above range, the melting point of the filler metal increases, which cannot be likely to sufficiently exhibit an effect of inhibiting the amount of the intermetallic compound formed in the welded portion.

### [Shape of Filler Metal]

The filler metal is preferably in a powdered state. In rod-shaped, wire-shaped, and foil-shaped filler metals to be generally used, an amount of heat required in order to melt the filler metal increases. When the amount of heat required in order to melt the filler metal increases, a thermal conduction amount due to thermal conduction to the copper-based base material also increases. This causes an increase in the production amount of the intermetallic compound. Meanwhile, the powdered filler metal has a surface area (specific surface area) per unit mass (or unit volume) increased compared to the rod-shaped, wire-shaped, and foil-shaped filler metals, whereby the light absorption for the irradiated laser light increases, and the amount of heat required for melting can be reduced, whereby the amount of heat to be charged may be reduced. As a result, the thermal conduction amount due to thermal conduction to the copper-based base material decreases, whereby the production amount of the intermetallic compound can be inhibited. Two kinds of powdered filler metal having different particle diameter sizes, i.e., a small-particle-diameter powdered filler metal A having an average particle diameter of 2 to 10 μm and a large-particle-diameter powdered filler metal B having an average particle diameter of 50 to 500 μm are desirably used in combination at a mass ratio of powdered filler metal A : powdered filler metal B=1:95 to 105 in order to improve the filling rate of the powdered filler metal. Furthermore, it is preferable that the powdered filler metal is supplied in contact with the copper-based member on the Al-based base material, and arranged as a powder, and the irradiation spot of the laser light is scanned over the surface of the powder. This makes it possible to shorten the time during which the welded portion is under high temperature, and inhibit the production amount of the inter metallic compound.

### [Method for Arranging Filler Metal]

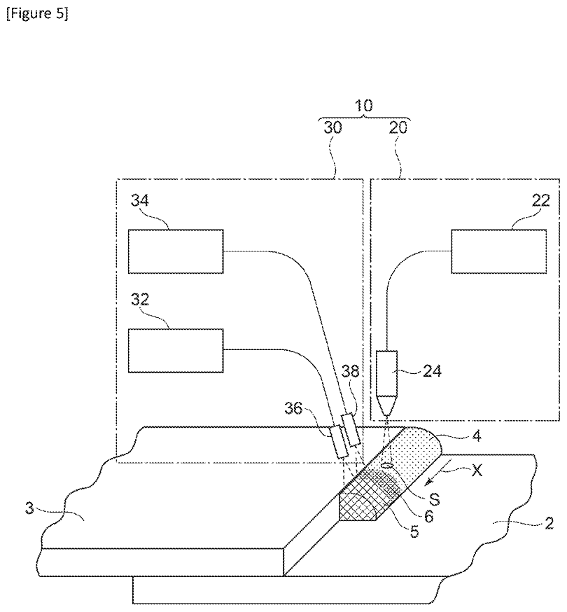

In the method for arranging the filler metal, the filler metal may be preliminarily arranged, or may be supplied immediately before laser irradiation (see FIG. 5). In any case, the filler metal is preferably arranged in contact with both the Al-based base material and the Cu-based base material. The amount of the filler metal to be provided may be appropriately adjusted according to the plate thickness and groove shape of each of the base materials. When a rod-shaped or wire-shaped filler metal is used, the amount of the filler metal to be provided can be adjusted by changing the wire diameter. When a powdered filler metal is used, the amount of the powdered filler metal to be supplied to a predetermined joining position may be appropriately adjusted. It is also possible to use a dispersing material containing polyethylene glycol or polyether and the like in order to improve the filling rate in the case of the powdered filler metal.

### (Ingredients (Constituting Powder) Other Than Filler Metal)

### [Fe Powder]

In another embodiment, it is preferable that a powder over which an irradiation spot of laser light is scanned further contains an Fe (iron) powder occupying an area ratio of 1% or more, and preferably 50% or more on a surface of the powder. The Fe powder has lower laser light reflectivity than that of the Al-based base material or the Cu-based base material, whereby the Fe powder can be used as a laser light absorbing auxiliary material. More specifically, the Fe (iron) powder is arranged on the surface of the powder, whereby the filler metal (powder) can be melted by lower energy. This further facilitates energy control for not remarkably melting the Al-based base material and the Cu-based base material.The area ratio occupied by the Fe powder on the surface of the powder is set to 1% or more because an effect of improving light absorption on the surface of the powder irradiated with the laserlight may not be sufficiently obtained when the area ratio is less than 1%.

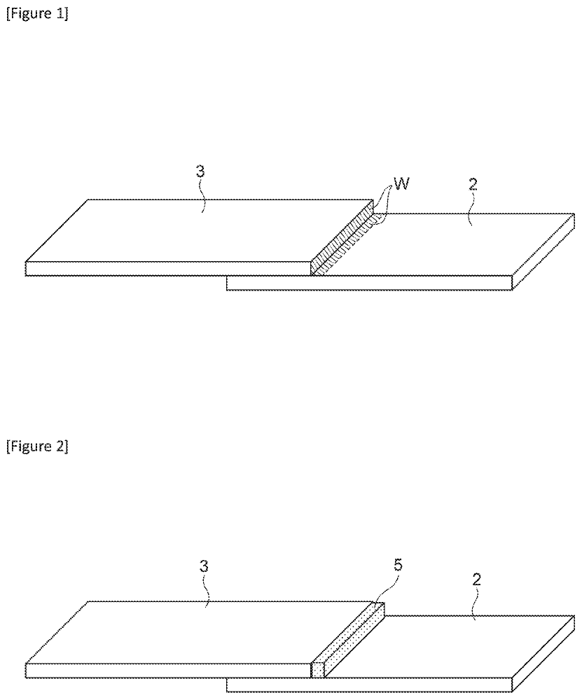

For example, as shown in FIG. 1, in the method for arranging an Fe powder, the powdered filler metal may be supplied to a predetermined joining position W, to arrange a powder 5 of the powdered filler metal, followed by arranging the Fe powder so that the surface of the powder 5 is covered with the Fe powder (not shown). In this case, the thickness of the layer of the Fe powder arranged so that the surface of the powder 5 is covered with the Fe powder is preferably 1 mm or less. When the thickness of the layer of the Fe powder is more than 1 mm, the Fe powder that the energy of laser does not effectively reach is present on the powder. This may inhibit the thermal conduction to the filler metal or the Al-based base material.

In another method for arranging the Fe powder, the powdered filler metal and the Fe powder may be mixed, followed by arranging a part of the mixed Fe powder so as to be exposed from the surface of the powder. In this case, the mixing ratio occupied by the Fe powder in the powdered filler metal (powder) is preferably 1 to 50% at a volume ratio. This is because, when the mixing ratio of the Fe powder is less than 1%, the area ratio occupied by the Fe powder on the surface of the powder cannot be set to be no less than 1%, which may not sufficiently provide an effect of improving light absorption on the surface of the powder irradiated with laser light. Meanwhile, this is because, when the mixing ratio of the Fe powder exceeds 50%, the filler metal cannot sufficiently flow, which may inhibit joining property. Furthermore, the average particle size of the iron powder is desirably 10 μm or more and 1000 μm or less.

### [Flux]

Furthermore, in another embodiment, a flux may be used in order to improve joining property. An Al oxide film is firm, and immediately reoxidized even if the Al oxide film is disrupted by laser to inhibit joining. Then, when the disruption of the oxide film is accelerated by the flux, the joining property is further improved. Examples of the flux include a fluoride-based flux or a chloride-based flux used when a normal Al-based base material is welded, or a mixture of fluoride-based and chloride-based fluxes. Examples of the fluoride-based flux include KAlF₄, K₂AlF₅, K₂AlF₅·H₂O, K₃AlF₅, AlF₃, KZnF₃, K₂SiF₅, Cs₃AlF₅, CsAlF₄·2H₂O, and Cs₂AlF₅·H₂O. These fluxes are used alone or as a mixture of two or more. Examples of the chloride-based flux include NaCl, KCl, LiCl, and ZnCl₂. These chloride-based fluxes are used alone or as a mixture of two or more. Among these, in particular, a non-corrosive fluoride-based flux having a low melting point and containing Cs and F is more preferably used. Specific examples of the non-corrosive fluoride-based flux include Cs₃AlF₅, CsAlF₄·2H₂O, and Cs₂AlF₅·H₂O. Examples of the mixture of fluoride-based and chloride-based fluxes include NaCl+KCl+Na₂SiF₆ and NaCl+KCl+NaF and the like.

The method for arranging the flux can be performed by any one of (I) a method for applying the flux over a portion including predetermined joining positions of the Al-based base material and the Cu-based base material before placing a filler metal, (II) a method for applying the flux on the surface of the filler metal (powder) after placing the filler metal, and (III) a method for mixing the flux with the powdered filler metal, or the combination of the two methods. In the above (III), the flux is preferably 10% or more at a volume ratio in the mixed powder (powder). When the volume ratio of the flux is less than 10%, an effect of accelerating the disruption of the oxide film may not be sufficiently obtained. When the volume ratio occupied by the flux in the mixed powder exceeds 50%, the filler metal is insufficient. This may cause significantly deteriorated joining property, whereby the volume ratio is preferably 50% or less. When the flux is mixed, the volume rate of the powdered filler metal is desirably 30% or more. When the volume rate of the powdered filler metal is less than 30%, the filler metal is insufficient. This may cause significantly deteriorated joining property.

### [Laser Welding]

### (Welding Shape)

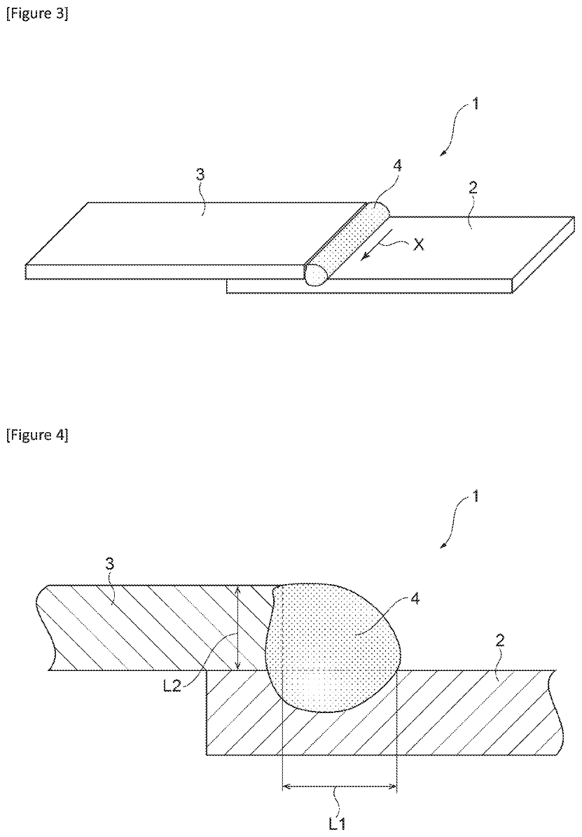

As shown in FIG. 2, in the present embodiment, two plates (lowerplate 2 and upper plate 3) made of an Al-based base material and a Cu-based base material are arranged so as to be overlaid, and a filler metal is then supplied to a predetermined joining position W (indicated by oblique lines in FIG. 1) with the upper plate 3 on the lowerplate 2, to arrange a powder 5 of a powdered filler metal as shown in FIG. 2. An irradiation spot S provided by condensing laser light emitted from a laser head of a laser welding device (FIG. 5) is scanned over the surface of the powder 5 of the powdered filler metal on the lower plate 2, whereby the lower plate 2 and the upper plate 3 are joined to each other to form a welded joint 1 shown in FIG. 3 and FIG. 4. In this case, it is preferable that the lower plate 2 is an Al-based base material, and the upper plate 3 is a Cu-based base material. As the joint shape of the welded joint 1, other joint shapes such as an abutting shape having a groove provided in an Al-based base material, and a butt joint shape can be employed in addition to a lap fillet shape shown in FIG. 3. The laser welding is desirably carried out in one pass from one side, but the laser welding may be performed a plurality of times depending on the plate thickness of the welded joint 1 as a joined body. When the laser welding is performed a plurality of times, the laser welding may include a step of arranging a filler metal again after welding.

### (Laser Irradiation Condition)

The irradiation position of laser preferably on the surface of the filler metal (powder 5) slightly offset on the surface side of the Al-based base material which is not an overlaid portion when the Al-based base material is the lower plate 2. This is because the Cu-based base material of the upper plate 3 has higher wettability with the filler metal than that of the Al-based base material 2, and when the filler metal is arranged on the Al-based base material 2 for welding, the melted filler metal sufficiently wets'for the Cu-based base material, whereby the Al-based base material 2 and the Cu-based base material 3 can be satisfactorily joined to each other.

It is preferable that heating according to the laser irradiation of the present embodiment is controlled so that the filler metal is melted in a wide range, and thermal conduction to the Cu-based base material is inhibited as much as possible. Therefore, it is preferable that a welding condition in the laser welding includes a power density of 50 kW/m² or less and a welding speed of 1 mm/s or more. When the power density exceeds 50 kW/m², a thermal conduction amount due to thermal conduction to the Cu-based base material increases. This may cause an increase in the amount of the intermetallic compound formed in the welded portion to cause decreased joint strength. There is a tendency that, when the welding speed is less than 1 mm/s, the cooling rate of the welded portion is small, whereby the production amount of the intermetallic compound increases. In addition, when the welding speed exceeds 2000 mm/s, the filler metal may be insufficiently melted, whereby a proper joined portion cannot be formed. The upper limit of the welding speed is therefore preferably 2000 mm/s. The laser to be used may be any of a continuous wave (CW) and a pulse wave (PW).

The spot diameter of the laser light to be irradiated is preferably 0.1 mm or more. When the spot diameter of the laser light is less than 0.1 mm, the filler metal is insufficiently melted. This may not provide a satisfactory joined body.

Furthermore, in order to prevent the oxidization of a weld metal portion 4, a shielding gas may be used during the laser welding. Inactive gases such as argon, nitrogen, and helium are used for the shielding gas, and are appropriately selected at a flow rate of 1 to 60 L/min.

The wavelength of the laser to be used is not particularly specified, and preferably 700 to 2000 nm. This is because Al has lower reflectivity than that of Cu in this wavelength, whereby the filler metal made of the Al-based alloy has higher light absorption.

### <Laser Welding Device>

Thereafter, the laser welding device of the present embodiment will be described below.

FIG. 5 is a schematic view of the laser welding device of the present embodiment, and illustrates an arrangement relationship among an upper plate, a lower plate, and a laser emission unit and a filler metal supply unit constituting the laser welding device.

A laser welding device 10 of the present embodiment is used for joining of different type of metals, the different type of metals being an Al-based base material 2 made of an Al alloy or pure Al and a Cu-based base material 3 made of a Cu alloy or pure Cu, and includes a laser emission unit 20 and a filler metal supply unit 30.

The laser emission unit 20 includes a laser oscillator 22 for oscillating laser and a laser head 24 irradiating laser light which has been oscillated and condensed. The laser emission unit 20 can scan an irradiation spot S of the laser light irradiated from the laser head 24 over the surface of the powder (in FIG. 5, the surface of an Fe powder 6 further arranged on the powder 5) while moving one of the laser head 24 and a stage (not shown) fixing the upper plate 3 and the lower plate 2 to be welded, relative to the other in a welding direction X.

The filler metal supply unit 30 includes a filler metal supply portion 32 and an Fe powder supply portion 34, and a filler metal supply head 36 and an Fe powder supply head 38.

The filler metal supply portion 32 stores the powdered filler metal made of the Al alloy containing at least one of Si and Cu, and supplies the stored powdered filler metal. The filler metal supply portion 32 supplies the powdered filler metal to the predetermined joining position W, to allow the powder 5 of the powdered filler metal to be arranged.

The Fe powder supply portion 34 stores the Fe powder, and supplies the stored Fe powder. The Fe powder supply portion 34 can supply and arrange the Fe powder 6 on the surface of the powder 5 arranged at the predetermined joining position W.

The filler metal supply head 36 can supply the powdered filler metal stored in the filler metal supply portion 32 by a predetermined amount to the predetermined joining position W.

The Fe powder supply head 38 can supply the Fe powder stored in the Fe powder supply portion 34 by a predetermined amount on the powder 5 placed at the predetermined joining position W.

The filler metal supply head 36 and the Fe powder supply head 38 are supplied in advance to the predetermined joining position W in the welding direction X synchronously with the laser head 24. In this case, as with the case of the laser head 24, the filler metal supply head 36 and the Fe powder supply head 38 may be allowed to be moved relative to the stage (not shown) fixing the upper plate 3 and the lower plate 2 to be welded. For example, the filler metal supply head 36 and the Fe powder supply head 38 may be moved, or the stage fixing the upper plate 3 and the lower plate 2 to be welded may be moved.

The above-described parts only show some examples of the present embodiment, and various changes can be made in the claims.

### EXAMPLES

Hereinafter, a description will be given in more detail based on Examples, but the present embodiment is not limited to these.

### Inventive Examples 1 to 15 and Comparative Examples 1 and 2

There were used two plates, i.e., an Al-based base material having a length of 100 mm, a width of 50 mm, and a thickness of 1 mm and made of A1050, and a Cu-based base material made of C1100. As shown in FIG. 3, the Al-based base material and the Cu-based base material were overlaid so that a lap fillet welded joint was formed, and then joined to each other by laser welding using a filler metal. Hereinafter, in the figures, numeral number 2 designates a lower plate, and numeral number 3 designates an upper plate.

Two kinds of rod-shaped filler metals made of A4047BY or an Al—Cu—Si—Zn alloy and having a diameter of 1.2 mm and three kinds of powdered filler metals made of an Al—Si alloy, an Al—Cu—Si alloy, or an Al—Cu—Si—Zn alloy were prepared as the filler metal. The powdered filler metal was produced by mixing a powder having an average particle diameter of 5 μm with a powder having an average particle diameter of 100 μm at a mass ratio of 1:100. Furthermore, the prepared powdered filler metal further contained Cs₃AlF₆ as a fluoride-based flux as a flux at a volume ratio of 20%. The filler metal was arranged at a position in contact with an end face of the upper plate 3 on the lower plate 2. When the powdered filler metal was used, the powder 5 of the powdered filler metal was arranged across the full width of the lower plate 2 in a thickness of 1.5 mm, a width of 1.5 mm, and a weld length of 50 mm at the position in contact with the end face of the upper plate 3.

The composition ingredients of A4047BY and Al—Cu—Si—Zn alloy as the rod-shaped filler metal used in Inventive Examples, and the composition ingredients of the Al—Si alloy, Al—Cu—Si alloy, and Al—Cu—Si—Zn alloy as the powdered filler metal are as follows.

### <Rod-Shaped Filler Metal>

### [A4047 BY]

Si: 12% by mass, Fe: 0.3% by mass, Balance: Al

### [Al—Cu—Si—Zn Alloy]

Cu: 20% by mass, Si: 5% by mass, Zn: 5% by mass, Balance: Al

### <Powdered Filler Metal>

### [Al—Si Alloy]

Si: 12% by mass, Balance: Al

### [Al—Cu—Si Alloy]

Cu: 20% by mass, Si: 5% by mass, Balance: Al

### [Al—Cu—Si—Zn Alloy]

Cu: 20% by mass, Si: 5% by mass, Zn: 5% by mass, Balance: Al

YLS2000 manufactured by IPG was used for laser welding, and the welding was performed by CW laser. The laser had a wavelength of 1070 nm. A spot diameter was 0.2 mm, and two output conditions of 2 kW and 1 kW were set. A power density when the output was 2 kW was about 70 kW/mm², and a power density when the output was 1 kW was about 35 kW/m². Three welding speed conditions of 0.5 mm/s, 1 mm/s, and 5 mm/s were set. Nitrogen was used for a shielding gas, and the flow rate of nitrogen was set to 20 L/min. The irradiation position of the laser was offset toward the side of the surface of the lower plate 2 on which the upper plate 3 was not overlaid by only 0.2 mm from the end face of the upper plate 3, and the laser was scanned in parallel to the end face of the upper plate 3, to join the Al-based base material and the Cu-based base material to each other, thereby producing a welded joint (joined body). During welding without using a filler metal, the position of the end face of the upper plate 3 was irradiated with the laser. In some Examples, an iron powder 6 having an average particle size of 100 μm as an absorbing auxiliary material was further added onto a surface of the powder 5 of the powdered filler metal before the irradiation of laser light. The iron powder 6 was added across the full width of the lower plate in a width of 0.15 mm, a thickness of 0.3 mm, and a weld length of 50 mm in a laser irradiation region on the powder 5 of the powdered filler metal. The irradiation region of the laser light had an area of 10 mm² (spot diameter: 0.2 mm weld length: 50 mm), whereas the area of the iron powder to be added was 7.5 (width: 0.15 mm×weld length: 50 mm). The area ratio occupied by the iron powder on the surface of the powder 5 was 75%.

The combination of the arrangement relationship between the Al-based base material and the Cu-based base material, the composition and shape of the filler metal, the presence or absence and volume ratio of the flux in the powder, the presence or absence of the absorbing auxiliary material (Fe powder) on the surface of the powder, the area ratio occupied by the absorbing auxiliary material (Fe powder) on the surface of the powder, and the laser irradiation conditions (power density and welding speed) in the laser welding are shown in Table 1.

### <Performance Evaluation>

Each of the produced welded joints was evaluated for the penetration shape and tensile shear strength (breaking load) of the weld metal portion.

### (i) Evaluation of Penetration Shape of Welded Portion

As shown in FIG. 3, for each of the produced welded joints, the penetration shape of a weld metal portion 4 in a cross section (FIG. 4) obtained by cutting the weld metal portion 4 perpendicular to the welding direction X was observed, and a leg length L1 of the weld metal portion 4 on the lower plate 2 side and a leg length L2 of the weld metal portion 4 on the upper plate 3 side were measured. The measurement results are shown in Table 2. In Table 2, the leg length L1 on the lower plate 2 side of 1.0 mm or more was evaluated as “good”, the leg length L1 of 0.7 mm or more and less than 1.0 mm was evaluated as “average”, and the leg length 1.1 of less than 0.7 mm was evaluated as “poor”.

The leg length L2 on the upper plate 3 side of 0.9 mm or more and 1.0 mm or less was evaluated as “good”, the leg length L2 of 0.7 mm or more and less than 0.9 mm was evaluated as “average”, and the leg length L2 of less than 0.7 mm was evaluated as “poor”.

### (ii) Method for Measuring Tensile Shear Strength (Breaking Load)

For each of the produced welded joints, a strip-like sample including a welded portion located at its center and having a width of 10 mm was produced. The sample was subjected to a tensile shear test to measure a breaking load. The measurement results are shown in Table 2. The breaking load shown in Table 2 of 1 kN or more was evaluated as “good”, the breaking load of 0.6 kN or more and less than 1.0 kN was evaluated as “average”, and the breaking load of less than 0.6 kN was evaluated as “poor”.

(iii) Comprehensive Evaluation

From the evaluation results of the above (i) and (ii), comprehensive evaluation was made based on comprehensive evaluation criteria to be shown below. The results are shown in Table 2.

### <Comprehensive Evaluation Criteria>

Very Good: both the leg lengths of the lower and upper plates in the above (i) were evaluated as “good”, and the breaking load in the above (ii) was also evaluated as “good”.
Good: any two of the leg lengths of the lower and upper plates in the above (i) and the breaking load in the above (ii) were evaluated as “good”, and the remaining one was evaluated as “average”.
Average: at least two of the leg lengths of the lower and upper plates in the above (i) and the breaking load in the above (ii) were evaluated as “average”, and the leg lengths and the breaking load were not evaluated as “poor”.
Poor: at least one of the leg lengths of the lower and upper plates in the above (i) and the breaking load in the above (ii) was evaluated as “poor”.

TABLE 1

| | | | | | | | Absorbing auxiliary | | Laser irradiation | |
|---|---|---|---|---|---|---|---|---|---|---|
| | | | | | Flux | | material (Fe powder) | | condition | |
| | | | | | | Volume | | Area | Power | Welding |
| | Upper | Lower | Filler metal | | Presence or | ratio | Presence or | ratio | density | speed |
| | plate | plate | Kind | Shape | absence | (%) | absence | (%) | (kW/mm²) | (mm/s) |
| Inventive Example 1 | C1100 | A1050 | Al—Si | Powder | Presence | 20 | Presence | 75 | 35 | 1 |
| Inventive Example 2 | C1100 | A1050 | Al—Cu—Si | Powder | Presence | 20 | Presence | 75 | 35 | 5 |
| Inventive Example 3 | C1100 | A1050 | Al—Cu—Si—Zn | Powder | Presence | 20 | Presence | 75 | 35 | 1 |
| Inventive Example 4 | C1100 | A1050 | Al—Cu—Si | Powder | Presence | 20 | Absence | | 35 | 5 |
| Inventive Example 5 | C1100 | A1050 | Al—Cu—Si—Zn | Powder | Absence | | Presence | 75 | 35 | 1 |
| Inventive Example 6 | C1100 | A1050 | Al—Cu—Si | Powder | Presence | 20 | Presence | 75 | 70 | 5 |
| Inventive Example 7 | C1100 | A1050 | Al—Cu—Si—Zn | Powder | Presence | 20 | Presence | 75 | 35 | 0.5 |
| Inventive Example 8 | A1050 | C1100 | Al—Cu—Si | Powder | Presence | 20 | Presence | 75 | 35 | 1 |
| Inventive Example 9 | C1100 | A1050 | Al—Cu—Si—Zn | Powder | Absence | | Absence | | 35 | 5 |
| Inventive Example 10 | C1100 | A1050 | Al—Cu—Si | Powder | Presence | 20 | Presence | 75 | 70 | 0.5 |

| | | | | | | | | |
|---|---|---|---|---|---|---|---|---|
| Inventive Example 11 | C1100 | A1050 | Al—Cu—Si—Zn | Powder | Absence | Absence | 70 | 0.5 |
| Inventive Example 12 | C1100 | A1050 | A4047BY | Rod | Absence | Absence | 35 | 1 |
| Inventive Example 13 | C1100 | A1050 | A4047BY | Rod | Absence | Absence | 70 | 0.5 |
| Inventive Example 14 | C1100 | A1050 | Al—Cu—Si—Zn | Rod | Absence | Absence | 70 | 0.5 |
| Inventive Example 15 | A1050 | C1100 | Al—Cu—Si | Powder | Absence | Absence | 35 | 5 |

| | | | | | | | |
|---|---|---|---|---|---|---|---|
| Comparative Example 1 | C1100 | A1050 | Absence | Absence | Absence | 35 | 1 |
| Comparative Example 2 | C1100 | A1050 | Absence | Absence | Absence | 70 | 0.5 |

TABLE 2

| | Upper plate | | Lower plate | | Tensile shear test | | |
|---|---|---|---|---|---|---|---|
| | Leg length L2 | | Leg length L1 | | Breaking load | | Comprehensive |
| | (mm) | Evaluation | (mm) | Evaluation | (kN) | Evaluation | evaluation |
| Inventive Example 1 | 1.0 | Good | 1.5 | Good | 1.4 | Good | Very Good |
| Inventive Example 2 | 1.0 | Good | 1.6 | Good | 1.8 | Good | Very Good |
| Inventive Example 3 | 1.0 | Good | 1.7 | Good | 1.8 | Good | Very Good |
| Inventive Example 4 | 1.0 | Good | 0.9 | Average | 1.1 | Good | Good |
| Inventive Example 5 | 1.0 | Good | 0.9 | Average | 1.2 | Good | Good |
| Inventive Example 6 | 1.0 | Good | 1.5 | Good | 0.8 | Average | Good |
| Inventive Example 7 | 1.0 | Good | 1.9 | Good | 0.9 | Average | Good |
| Inventive Example 8 | 0.8 | Average | 1.1 | Good | 1.1 | Good | Good |
| Inventive Example 9 | 0.9 | Good | 0.8 | Average | 1.0 | Good | Good |
| Inventive Example 10 | 1.0 | Good | 2.2 | Good | 0.8 | Average | Good |
| Inventive Example 11 | 0.9 | Good | 0.8 | Average | 0.6 | Average | Average |
| Inventive Example 12 | 0.9 | Good | 0.8 | Average | 0.8 | Average | Average |
| Inventive Example 13 | 1.0 | Good | 1.1 | Good | 0.6 | Average | Good |
| Inventive Example 14 | 1.0 | Good | 1.2 | Good | 0.8 | Average | Good |
| Inventive Example 15 | 0.7 | Average | 0.8 | Average | 0.9 | Average | Average |
| Comparative Example 1 | 1.0 | Good | 0.8 | Average | 0.5 | Poor | Poor |
| Comparative Example 2 | 1.0 | Good | 1.2 | Good | 0.4 | Poor | Poor |

From the evaluation results shown in Table 2, the joining joints of Inventive Examples 1 to 15 produced by the joining method (laser welding) according to the present embodiment included the lower plate having a leg length of 0.8 mm or more, the upper plate having a leg length of 0.7 mm or more, and the welded portion having a good penetration shape, and had the breaking load of 0.6 kN or more in the tensile shear test, i.e., high joint strength. Meanwhile, Comparative Examples 1 and 2 produced by the laser welding without using the filler metal included the welded portion having a good penetration shape, but Comparative Examples 1 and 2 had the breaking load of 0.5 kN or less in the tensile shear test, i.e., insufficient joint strength.

### INDUSTRIAL APPLICABILITY

The present embodiment can provide a method for joining different type of metals, and a laser welding device. The method and the laser welding device eliminate the need for strict control of a laser irradiation position and also can manufacture a welded joint of Al-based and Cu-based base materials having high joint strength.

### LIST OF REFERENCE SIGNS

1: welded joint
2: lower plate
3: upper plate
4: weld metal portion
5: powder (or filler metal)
6: Fe powder
10: laser welding device
20: laser emission unit
22: laser oscillator
24: laser head
30: filler metal supply unit
32: filler metal supply portion
34: Fe powder supply portion
36: filler metal supply head
38: Fe powder supply head
X: welding direction

What is claimed is:

1. A method for joining different type of metals, the different type of metals being an Al-based base material made of an Al alloy or pure Al and a Cu-based base material made of a Cu alloy or pure Cu,
wherein:
the Al-based base material and the Cu-based base material are joined to each other by laser welding for melting and solidifying a portion irradiated with laser light using a filler metal made of an Al alloy containing at least one of Si and Cu; and
the filler metal is an Al—Cu—Si-based alloy or an Al—Cu—Si—Zn-based alloy.

2. (canceled)

3. The method for joining different type of metals according to claim 1, wherein the filler metal is a powdered filler metal.

4. The method for joining different type of metals according to claim 3,
wherein:
a powder of the powdered filler metal is arranged in contact with the Cu-based base material on the Al-based base material; and
an irradiation spot of the laser light is scanned over a surface of the powder.

5. The method for joining different type of metals according to claim 4, wherein the powder over which the irradiation spot of the laser light is scanned further contains an Fe powder occupying an area ratio of 1% or more on the surface of the powder.

6. The method for joining different type of metals according to any one of claims 3 to 5, wherein the powder of the powdered filler metal ur her contains a flux at a volume ratio of 10% or more.

7. The method for joining different type of metals according to any one of claims 1 and 3 to 6, wherein a welding condition in the laser welding includes a power density of 50 kW/mm² or less and a welding speed of 1 mm/s or more.

8. A laser welding device used for joining different type of metals, the different type of metals being an Al-based base material made of an Al alloy or pure Al, and a Cu-based base material made of a Cu alloy or pure Cu,
wherein:
the laser welding device includes a laser emission unit and a filler metal supply unit;
the filler metal supply unit includes a filler metal supply portion storing a powdered filler metal made of an Al alloy containing at least one of Si and Cu and supplying the stored powdered filler metal, and an Fe powder supply portion storing an Fe powder and supplying the stored Fe powder;
the filler metal supply portion supplies the powdered filler metal to a predetermined joining position, to allow a powder of the powdered filler metal to be arranged;
the Fe powder supply portion can supply and arrange the Fe powder on a surface of the powder arranged at the predetermined joining position; and
the laser emission unit can scan an irradiation spot of laser light over the surface of the powder on which the Fe powder is arranged.
